(19) United States
(12) Patent Application Publication
(10) Pub. No.: US 2026/0131869 A1
(43) Pub. Date: May 14, 2026

(54) BICYCLE MID-DRIVE MOTOR ASSEMBLY STRUCTURE

(71) Applicants: ATECH TOTALSOLUTION CO., LTD., New Taipei City (TW); YEGUAN INDUSTRY CO., LTD., New Taipei City (TW)

(72) Inventors: LI-HO YAO, Taipei City (TW); CHI-CHEN TIEN, New Taipei City (TW)

(21) Appl. No.: 19/379,774

(22) Filed: Nov. 5, 2025

(30) Foreign Application Priority Data
Nov. 14, 2024 (TW) 113143805

(51) Int. Cl. B62M 6/55; B62M 6/70

(52) U.S. Cl. CPC B62M 6/55; B62M 6/70

(57) ABSTRACT

A bicycle mid-drive motor assembly structure is applicable to a vehicle frame of a bicycle. The vehicle frame includes an axle through-tube in which a crank axle is mounted for driving a front chainwheel. The mid-drive motor assembly structure includes a motor and a clutch set. The clutch set includes a crank axle sleeve, a support sleeve, a clutch wheel, a cover cap, and a transmission wheel. With the crank axle sleeve and the support sleeve respectively sleeved on and mounted to the crank axle and the axle through-tube, the clutch wheel, the cover cap, and the transmission wheel can be effectively aligned and positioned, effectively increasing the axial locking force and the radial supporting force, making power transmission stable and reliable, also preventing loosening resulting from vibration during operation and preventing wear resulting from poor meshing, thereby effectively extending the service life.

### BACKGROUND OF THE INVENTION

### (a) Technical Field of the Invention

The present invention belongs to the technical field of mid-drive motor assembly.

### (b) Description of the Prior Art

Currently, mid-drive motors in electric-assisted bicycles are mostly integrated with the vehicle frame for aesthetics and structural strength. In case of limited sales, this arrangement will significantly increase the manufacturing and material costs. To address this, assembled mid-drive motors have been proposed, such as Taiwan Patent Publication No. 201307148, which discloses an “Assembled Transmission Structure for Bicycles”, in which to improve stability, a motor is mounted to two sides of an axle through-tube of the bicycle crank axle by means of two side brackets. This makes the structure complicated and also makes installation and removal more inconvenient. Furthermore, it also suffers insufficiency of pressing when fastened and difficult in component alignment and positioning, and the weight of the motor and the reduction set concentrated on one side, resulting in insufficient axial locking and radial supporting forces, leading to unstable and unreliable power transmission. Furthermore, loosening may easily occur due to vibration, causing poor meshing and thus wear of the transmission gears, so as to directly affect the service life. Therefore, further improvement is clearly needed, and this is also the subject of the present invention.

### SUMMARY OF THE INVENTION

The primary objective of the present invention is to provide a solution, which without modifying an existing vehicle frame, allows a mid-drive motor to be assembled on and mounted to the vehicle frame to provide a bicycle to which it is applied with an electric-assisted driving effect, for reducing the cost of the electric-assisted bicycle.

A secondary objective of the present invention is to allow each component to be effectively aligned and positioned, in order to increases the axial locking force and the radial supporting force to make power transmission more stable and more reliable thereby enhancing the practicability thereof.

A further objective of the present invention is to provide effective pressing and locking, preventing loosening resulting from vibration during operation, and preventing wear resulting from poor meshing, thereby effectively extending the service life.

### BRIEF DESCRIPTION OF THE DRAWINGS

FIG. 1 is a schematic perspective view showing the present invention used on a vehicle frame.

FIG. 2 is a schematic perspective view showing inside details of the present invention used on the vehicle frame.

FIG. 3 is a perspective exploded view of the present invention.

FIG. 4 is a perspective exploded view of the present invention taken from a different view angle.

FIG. 5 is a schematic enlarged view showing a portion of the present invention.

FIG. 6 is schematic cross-sectional view of a portion of a motor of the present invention.

FIG. 7 is a schematic cross-sectional view of the present invention.

FIG. 8 is a perspective exploded view showing a suspension assembly of the present invention.

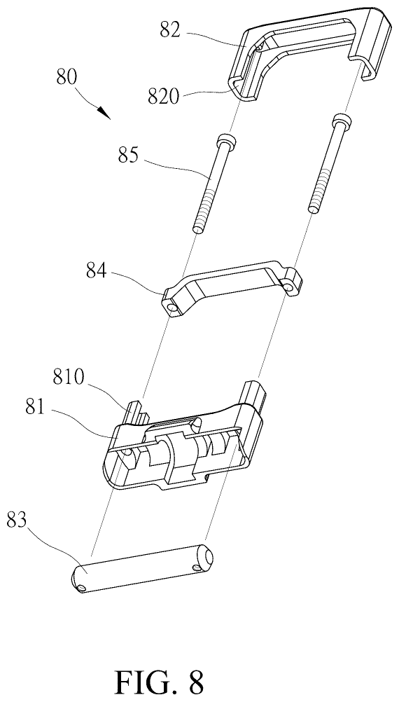

FIG. 9 is a schematic view illustrating driving achieved by pedaling a crank axle in an actual operation of the present invention.

FIG. 10 is a schematic view illustrating driving achieved by the motor in an actual operation of the present invention.

### DETAILED DESCRIPTION OF THE PREFERRED EMBODIMENTS

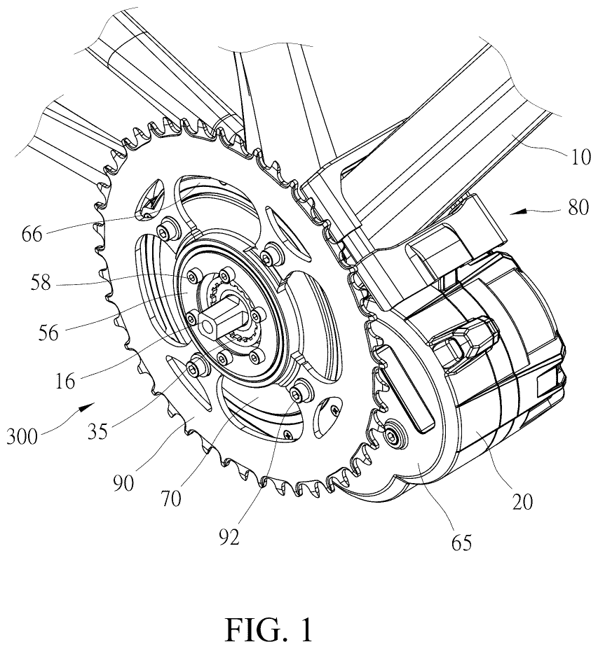

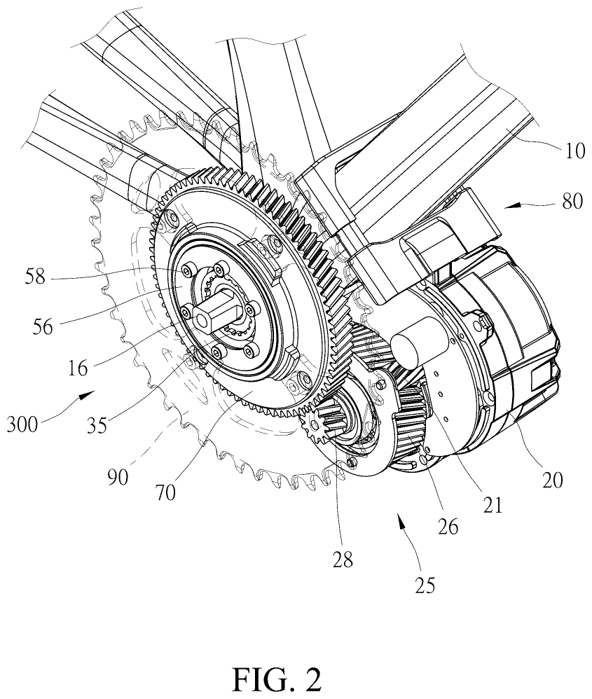

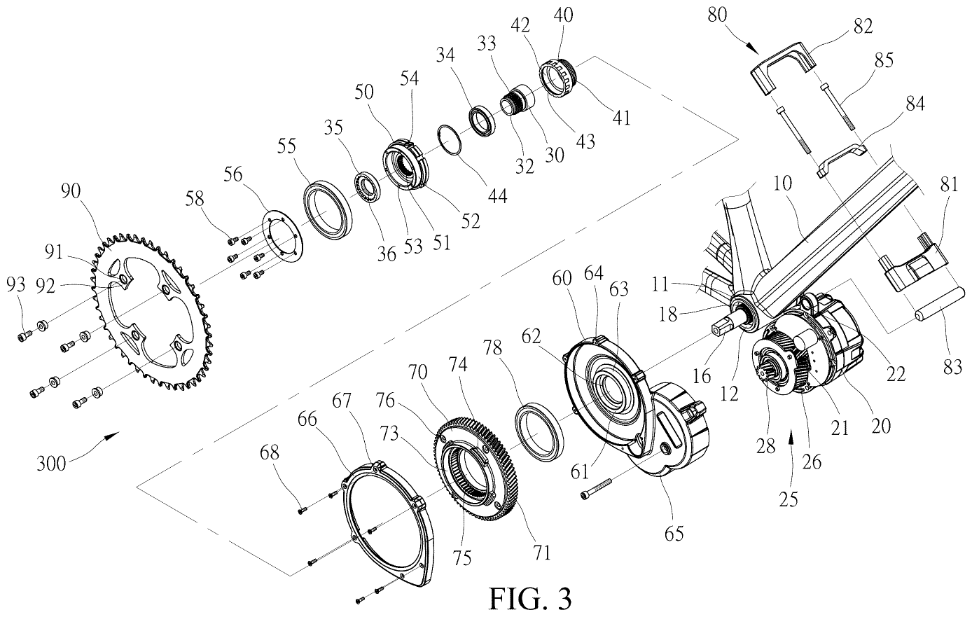

As shown in FIGS. 1 and 2, the present invention is applicable to mounting on a vehicle frame 10 of a general-purpose bicycle. The vehicle frame 10 includes an axle through-tube 11 (see FIG. 3) for mounting a crank axle 16 to drive a front chainwheel 90, in order to achieve the purpose of driving the bicycle through various power sources. The mid-drive motor assembly structure comprises a motor 20 and a clutch set 300.

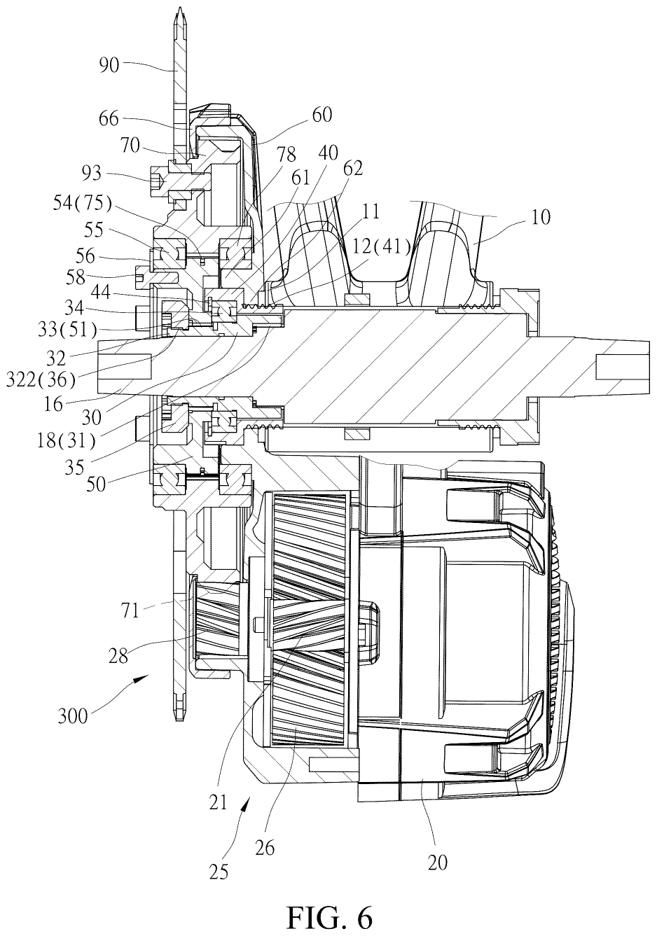

A detailed structure is illustrated in FIGS. 2, 3, and 6. The motor 20 is optionally mounted to and suspended on the vehicle frame 10. The motor 20 includes an output wheel axle 21. Further, the motor 20 is provided with a reduction set 25 that is actuated by the output wheel axle 21 to operate, with a reduced speed, the clutch set 300. The reduction set 25 includes a reduction wheel 26 meshed with the output wheel axle 21. The reduction wheel 26 drives a drive wheel 28 that drives the clutch set 300.

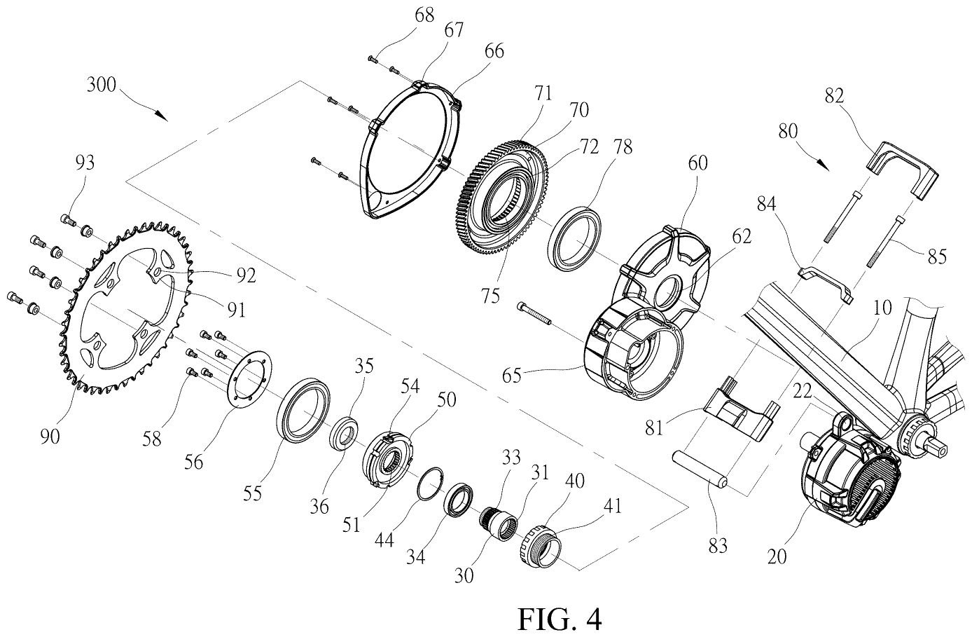

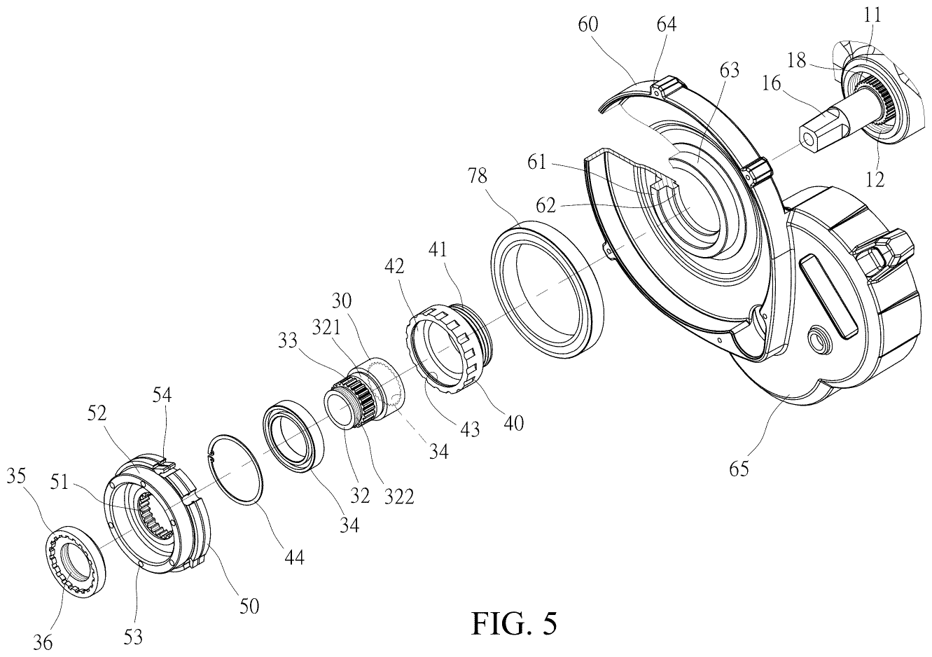

As shown in FIGS. 3, 4, 5, and 7, the clutch set 300 includes a crank axle sleeve 30, a support sleeve 40, a clutch wheel 50, a cover cap 60, and a transmission wheel 70, wherein the inner surface of one end of the crank axle sleeve 30 that corresponds to the crank axle 16 is formed with a plurality of first straight teeth 31 parallel to the axis, and the crank axle 16 includes second straight teeth 18 corresponding thereto and engageable therewith, so that the crank axle sleeve 30 can be driven the crank axle 16 in synchronization therewith. Further, protruding from the opposite side of the crank axle sleeve 30 is a protruding axle portion 32 that is sleeved on the crank axle 16. The middle portion of the protruding axle portion 32 of the crank axle sleeve 30 is provided with a first engagement tooth section 33 including a plurality of teeth parallel to the axis for engagement with the clutch wheel 50 to rotate synchronously. The protruding axle portion 32 is provided, on portions located inward and outward of the first engagement tooth section 33, with a first bearing seat section 321 and a first threading section 322 (see FIG. 5) for respectively mounting a first bearing 34 and a locking nut 35, wherein the inner circumference of the locking nut 35 includes a second threading section 36 corresponding to the first threading section 322, for locking, in a direction from outside to inside, the clutch wheel 50 and the first bearing 34 on the protruding axle portion 32 of the crank axle sleeve 30.

Further, the support sleeve 40 includes a threading protruding collar 41 corresponding to the axle through-tube 11, and the axle through-tube 11 includes a threading section 12 correspondingly meshed therewith, so that the threading protruding collar 41 of the support sleeve 40, after extending through the cover cap 60, can be fastened to the threading section 12 of the axle through-tube 11 to have the cover cap 60 clamped by the support sleeve 40 to fix to the end of the axle through-tube 11. Further, the support sleeve 40 includes a first inner bearing seat 42 corresponding to the first bearing 34, and a circumferential retaining groove 43 is formed in the first inner bearing seat 42 at a location adjacent to an open end thereof to optionally receive a circlip 44 to fit therein for retaining purposes in order to position and constrain the first bearing 34, allowing the crank axle sleeve 30 to freely rotate relative to the cover cap 60 and the support sleeve 40 are fixed.

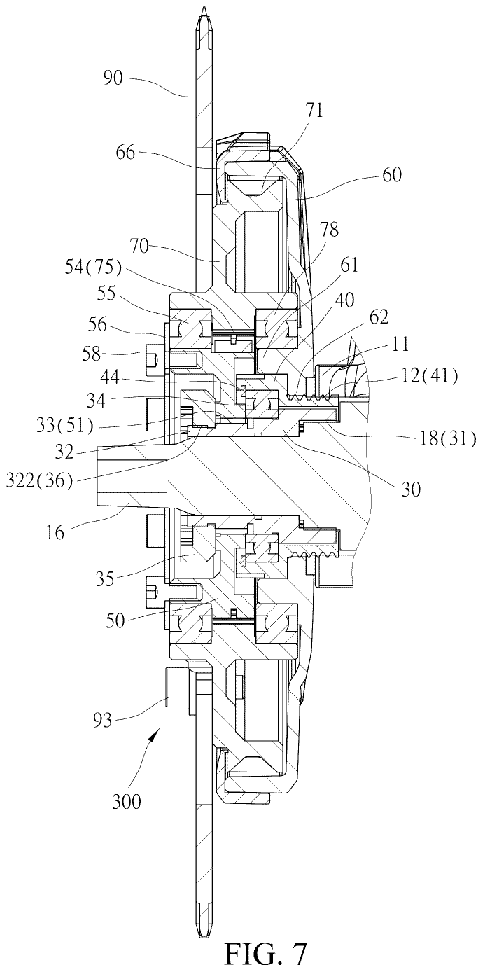

Further, the clutch wheel 50 is provided, in the center thereof, with a second engagement tooth section 51 corresponding to the first engagement tooth section 33 of the crank axle sleeve 30, and one side of the clutch wheel 50 that is opposite to the cover cap 60 is formed with a second bearing seat section 52 for mounting a second bearing 55 (see FIG. 7). Further, the clutch wheel 50 is provided with a plurality of locking holes 53 formed in an end face of the second bearing seat section 52 for application of a plurality of bolts 58 to fasten and fix a pressing board 56 to the clutch wheel 50 to constrain the second bearing 55. Further, the outer circumference of the clutch wheel 50 is formed with a plurality of clutch pawls 54, so that the crank axle sleeve 30 can drive the front chainwheel 90 by means of the clutch wheel 50 driving the transmission wheel 70 in one way.

Further, the cover cap 60 is provided, on the side thereof opposite to the vehicle frame 10, with a protruding axle collar 61 arranged in the center thereof. The inner circumference of the protruding axle collar 61 is formed with a stop rim 62 between and abutting against the support sleeve 40 and the axle through-tube 11. Further, the protruding axle collar 61 is provided with a third bearing seat section 63 for mounting a third bearing 78 (see FIG. 7). Further, the cover cap 60 is formed, on the circumference thereof, with a plurality of locking hole portions 64 for receiving a ring cover 66 to fasten and attach thereto. Also, the cover cap 60 is provided, on the circumference thereof, with a side cover 65 that corresponds to and covers the reduction set 25 of the motor 20. The ring cover 66 includes a plurality of counterbore portions 67 corresponding to the locking hole portions 64 for application of a plurality of bolts 68 to fasten and fix the ring cover 66 to the cover cap 60 for parts protection.

The outer circumference of the transmission wheel 70 includes a series of engagement teeth 71 that is meshed with the drive wheel 28 of the reduction set 25. Also, the transmission wheel 70 is provided, on the center thereof, with a third inner bearing seat 72 corresponding to the cover cap 60 to receive the third bearing 78 mounted on the third bearing seat section 63 of the cover cap 60 to fit therein. Further, one side of the transmission wheel 70 that corresponds to the front chainwheel 90 is formed with a second inner bearing seat 73. Further, the second inner bearing seat 73 is provided with a plurality of raised connection portions 74 arranged thereon in an equally spaced manner. Further, the transmission wheel 70 is formed, in a surface thereof, with a plurality of first fastening holes 76 corresponding to the raised connection portions 74 to receive the front chainwheel 90 to fasten and connect thereto. Further, the inner circumference of the transmission wheel 70 is formed with a series of clutching teeth 75 corresponding to the clutch pawls 54 of the clutch wheel 50 for selective engagement by the clutch pawls 54 on the outer circumference of the clutch wheel 50, so that the clutch wheel 50 can selectively drive the transmission wheel 70 to drive the front chainwheel 90, to thereby drive the bicycle.

The inner circumference of the front chainwheel 90 is formed with a plurality of protruding connection tabs 91 corresponding to the raised connection portions 74 of the transmission wheel 70. Further, the protruding connection tabs 91 of the front chainwheel 90 each include a second fastening hole 92, so that the front chainwheel 90 can use a plurality of fastening elements 93 to correspondingly fasten the first and second fastening holes 76, 92 of the transmission wheel 70 and the front chainwheel 90, making the transmission wheel 70 and the front chainwheel 90 synchronously rotatable.

According to some embodiments, the motor 20 can be mounted and suspended on the vehicle frame 10 by using a suspension assembly 80, wherein the motor 20 includes a mounting collar 22 for mounting at the lower side of the axle through-tube 11 of the vehicle frame 10 through the suspension assembly 80. The suspension assembly 80 includes a first clamp bar 81 and a second clamp bar 82 that can clamp and fix to the vehicle frame 10 from opposite sides. The first and second clamp bars 81, 82 are respectively provided, on each of two ends thereof, with a guide post 810 and a guide groove 820 that are insertable into and engageable with each other. A locking axle 83, which is inserted into the mounting collar 22 of the motor 20 is arranged on a bottom of the first clamp bar 81. Further, an elongated pressing plate 84 is arranged between the second clamp bar 82 and the vehicle frame 10, and two elongated threading rods 85 are sequentially inserted through and fastening the second clamp bar 82, the elongated pressing plate 84, the first clamp bar 81, and two ends of the locking axle 83 to have the motor 20 optionally fastened and fixed to the vehicle frame 10 by means of the suspension assembly 80.

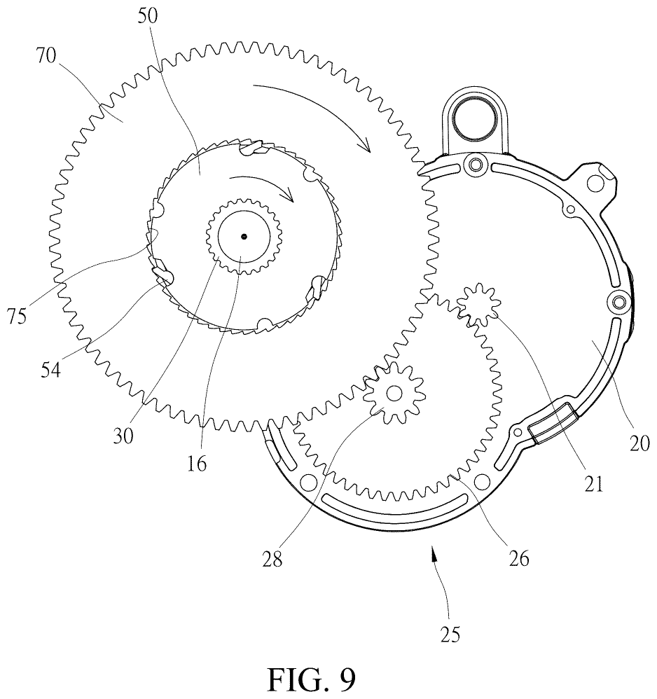

In an actual way of use of the present invention, as shown in FIGS. 1, 2, 6, and 7, when the crank axle 16 by manually pedaling the bicycle, the crank axle 16 synchronously drives the crank axle sleeve 30 and the clutch wheel 50, causing the clutch pawls 54 of the clutch wheel 50 to get into engagement with the clutching teeth 75 of the transmission wheel 70 (see FIG. 9) so as to synchronously actuate and operate the transmission wheel 70 to then synchronously drive the front chainwheel 90 that is fastened to the transmission wheel 70 to thereby drive a rear wheel (not shown in the drawings) through a chain, thereby achieving driving of the bicycle. Conversely, for pedaling being made in the reverse direction and actuating the crank axle 16 reversely, after the crank axle 16 drives the crank axle sleeve 30 and the clutch wheel 50, the clutch wheel 50 rotates in the reverse direction, so as to cause the clutch pawls 54 not to engage the clutching teeth 75 of the transmission wheel 70, thereby preventing the transmission wheel 70 and the front chainwheel 90 from being driven in the reverse. direction.

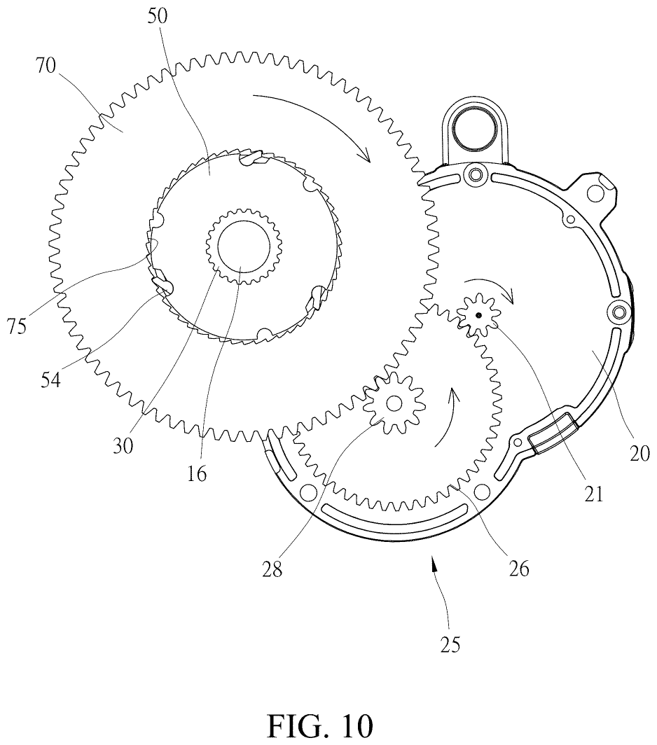

Further, in case that it is necessary to use the motor 20 to provide assisting power, reference being had to FIGS. 2, 6, 7, and 10, the output wheel axle 21 of the motor 20 actuates and operates the reduction wheel 26 of the reduction set 25 so as to drive the drive wheel 28 to actuate and operate the transmission wheel 70 to synchronously drive the front chainwheel 90 fastened to and mounted to the transmission wheel 70, thereby achieving driving of the bicycle. Further, when the rotational speed of the transmission wheel 70 as being driven by the motor 20 is greater than the rotational speed of the transmission wheel 70 actuated by the crank axle 16, the clutch wheel 50 becomes a transmitting decoupled condition with respect to the transmission wheel 70, making the clutching teeth 75 of the transmission wheel 70 in a state of disengaging from the clutch pawls 54 of the clutch wheel 50, so that the transmission wheel 70 does not cause interference with the crank axle 16 and the motor 20 is allowed to supply power to assist driving the bicycle.

Through the arrangement mentioned above and the description, the present invention provides that the crank axle sleeve 30 is sleeved on the crank axle 16, and the support sleeve 40 is screwed and mounted on the axle through-tube 11 of the vehicle frame 10, and then, the clutch wheel 50, the cover cap 60, and the transmission wheel 70 are assembled and attached to the crank axle sleeve 30 and the support sleeve 40, so that each of the components is effectively aligned and positioned, effectively increasing the axial locking force and radial supporting force, making the power transmission more stable and more reliable. Also, the crank axle sleeve 30, the support sleeve 40, the clutch wheel 50, the cover cap 60, and the transmission wheel 70 can be effectively pressed and locked, preventing loosening resulting from vibration during operation, and preventing wear resulting from poor meshing, thereby effectively extending the service life and thus, the motor 20 can be assembled on and mounted to the vehicle frame 10 using the suspension assembly 80, without modification of the existing vehicle frame, to provide the bicycle to which it is applied with an electric-assisted driving effect, thereby reducing the cost of the electric-assisted bicycle and improving the practicality thereof.

I claim:

1. A bicycle mid-drive motor assembly structure, which is applicable to a vehicle frame of a bicycle, wherein the vehicle frame includes an axle through-tube in which a crank axle is mounted for driving the bicycle by actuating a front chainwheel mounted on the crank axle, the mid-drive motor assembly structure comprising a motor that is selectively mounted to the vehicle frame and a clutch set arranged at one end of the crank axle, wherein the clutch set comprises:
a crank axle sleeve, of which an inner surface of one end corresponding to the crank axle is formed with first straight teeth, and the crank axle comprises second straight teeth corresponding thereto and engageable therewith, a protruding axle portion protruding from an opposite side of the crank axle sleeve to sleeve on the crank axle, a middle portion of the protruding axle portion of the crank axle sleeve being provided with a first engagement tooth section, a portion of the protruding axle portion that is located inward of the first engagement tooth section being provided with a first bearing seat section for mounting a first bearing;
a support sleeve, which comprises a threading protruding collar corresponding to the axle through-tube, and the axle through-tube includes a threading section for being meshed therewith, the support sleeve comprising includes a first inner bearing seat corresponding to the first bearing;
a clutch wheel, which is provided, in a center thereof, with a second engagement tooth section corresponding to the first engagement tooth section of the crank axle sleeve, one side of the clutch wheel that is opposite to the vehicle frame being formed with a second bearing seat section for mounting a second bearing, clutch pawls being provided on an outer circumference of the clutch wheel;
a cover cap, which is provided, on a one side thereof opposite to the vehicle frame, with a protruding axle collar arranged in a center thereof to sleeve on the support sleeve, the protruding axle collar being formed with a third bearing seat section, a ring cover being attached to a circumference of the cover cap; and
a transmission wheel, of which an outer circumference is formed with engagement teeth meshed with the motor, the transmission wheel being provided, in a center thereof, with a third inner bearing seat corresponding to the cover cap for mounting, in combination with the third bearing seat section of the cover cap, a third bearing, one side of the transmission wheel that corresponds to the front chainwheel being formed with a second inner bearing seat for mounting, in combination with the second bearing seat section of the clutch wheel, the second bearing, the transmission wheel being formed, in an inner circumference thereof, with clutching teeth to correspond to the clutch pawls of the clutch wheel, the front chainwheel being coaxially mounted to an outside surface of the transmission wheel.

2. The bicycle mid-drive motor assembly structure according to claim 1, wherein the motor comprises an output wheel axle, the motor being provided with a reduction set driven by the output wheel axle, the reduction set comprising a reduction wheel meshed with the output wheel axle, the reduction wheel driving a drivable drive wheel, wherein the drive wheel is engageable with the engagement teeth on the outer circumference of the transmission wheel.

3. The bicycle mid-drive motor assembly structure according to claim 1, wherein the protruding axle portion of the crank axle sleeve is provided, on a portion outward of the first engagement tooth section, with a first threading section for mounting a locking nut, an inner circumference of the locking nut being provided with a second threading section corresponding to the first threading section for fixing the clutch wheel and the first bearing on the protruding axle portion of the crank axle sleeve.

4. The bicycle mid-drive motor assembly structure according to claim 1, wherein the first inner bearing seat of the support sleeve is formed, at a location adjacent to an open end thereof, with a circumferential retaining groove for optionally receiving a circlip to fit therein for positioning the first bearing.

5. The bicycle mid-drive motor assembly structure according to claim 1, wherein the clutch wheel is provided with locking holes formed in an end face of the second bearing seat section for receiving bolts to fix a pressing board to the clutch wheel to constrain the second bearing.

6. The bicycle mid-drive motor assembly structure according to claim 1, wherein the protruding axle collar of the cover cap is provided, on an inner circumference thereof, with a stop rim between and abutting against the support sleeve and the axle through-tube to have the cover cap clamped between the support sleeve and the axle through-tube.

7. The bicycle mid-drive motor assembly structure according to claim 1, wherein the cover cap is formed, on a circumference thereof, with locking hole portions, and the ring cover comprises counterbore portions corresponding to the locking hole portions for receiving bolts to fix the ring cover to the cover cap.

8. The bicycle mid-drive motor assembly structure according to claim 7, wherein the cover cap is provided, on the circumference thereof, with a side cover that corresponds to and covers the motor.

9. The bicycle mid-drive motor assembly structure according to claim 6, wherein the cover cap is formed, on a circumference thereof, with locking hole portions, and the ring cover comprises counterbore portions corresponding to the locking hole portions for receiving bolts to fix the ring cover to the cover cap.

10. The bicycle mid-drive motor assembly structure according to claim 9, wherein the cover cap is provided, on the circumference thereof, with a side cover that corresponds to and covers the motor.

11. The bicycle mid-drive motor assembly structure according to claim 1, wherein one side surface of the transmission wheel that corresponds to the front chainwheel is formed with a second inner bearing seat, the second inner bearing seat being provided with raised connection portions, a surface of the transmission wheel being formed with first fastening holes corresponding to the raised connection portions, the front chainwheel being formed, on an inner circumference thereof, with protruding connection tabs corresponding to and engaging with the raised connection portions, the protruding connection tabs of the front chainwheel being each formed with a second fastening hole to allow the front chainwheel to be fastened by fastening elements to the transmission wheel.

12. The bicycle mid-drive motor assembly structure according to claim 1, wherein the motor is mounted by a suspension assembly to the vehicle frame, the motor comprising a mounting collar, the suspension assembly comprising a first clamp bar and a second clamp bar that clamp the vehicle frame from opposite sides, the first and second clamp bars being respectively provided, on each of two ends thereof, with a guide post and a guide groove insertable into and engageable with each other, a locking axle being arranged on a bottom the first clamp bar for insertion into the mounting collar, an elongated pressing plate being arranged between the second clamp bar and the vehicle frame, wherein two elongated threading rods respectively inserted, in sequence, through the second clamp bar, the elongated pressing plate, the first clamp bar, and two ends of the locking axle to have the motor optionally mounted to the vehicle frame by the suspension assembly.
